(19) United States
(12) Patent Application Publication
(10) Pub. No.: US 2015/0219411 A1
(43) Pub. Date: Aug. 6, 2015

(54) AIR-CONDITIONING SYSTEM

(71) Applicant: Ringdale, Inc., Georgetown, TX (US)

(72) Inventor: Klaus Bollmann, Georgetown, TX (US)

(21) Appl. No.: 14/425,271

(22) PCT Filed: Aug. 29, 2013
(86) PCT No.: PCT/US13/57262

§ 371 Date: Mar. 2, 2015

Related U.S. Application Data
(60) Provisional application No. 61/695,935, filed on Aug. 31, 2012.

(51) Int. Cl. F28F 27/02; F25B 21/02; C02F 1/44; B01D 35/02; B01D 61/02; F25D 21/14; F28F 19/01

(52) U.S. Cl. CPC F28F 27/02; F25D 21/14; F25B 21/02; F28F 19/01; B01D 35/02; B01D 61/025; C02F 1/441; F25B 2321/002; F25B 2321/02; C02F 2103/023

(57) ABSTRACT

The disclosed subject matter provides an air-conditioning system that is a total single room system or provides localized comfort zones in a larger space. This system can be produced at a very low cost and is highly efficient, combining known heat transport technologies to make a cooling or heating unit that will work in efficiently insulated rooms with little heat loss. This system allows a number of heat pump and air handler arrangements to be utilized.

### CROSS-REFERENCE TO RELATED APPLICATIONS

This applications claims priority to U.S. Provisional Patent Application Ser. No. 61/695,935, filed Aug. 31, 2012, and PCT Patent Application Serial No. PCT/US13/57262, filed Aug. 29, 2013, which are both hereby incorporated by reference in their entireties.

### FIELD OF THE INVENTION

The present disclosure relates in general to the field of air-conditioning systems, more particularly an air-conditioning system that allows multiple heat pump and air handler arrangements to be used.

### BACKGROUND OF THE INVENTION

Air-conditioning systems currently available rely heavily on large ducting systems. It is a known problem that these large-scale ducting systems can lose large amounts of cooling energy within the ducts.

Traditional air-conditioning systems available are often difficult to control and waste precious natural resources. Typical air-conditioning units use refrigeration techniques to cool inside air. A typical unit consists of an evaporator, condenser, expansion valve, and compressor.

Air-conditioning units can be centrally installed or isolated to a particular window. Centrally installed units may lose efficiency in the ducting systems while window units may be problematic to install and difficult to control. Both central and window units may exhibit problems with correct sizing, noise concerns, energy efficiency, and cost. Condensate extracted from the air is generally wasted or left in drip pans to form a platform for growing bacteria. Creating a system of air-conditioning units that are modular in nature may allow for more efficient and compartmentalized heating and cooling of individual air spaces. Larger centralized air-conditioning systems currently available typically heat and cool air in excess amounts and waste precious resources.

Accordingly, there is a need for advancement in the art, which is able to overcome the limitations associated with ducted air-conditioning systems.

### BRIEF SUMMARY OF THE INVENTION

The present disclosure outlines a system that can be cost efficient to produce, has a reduced electricity requirement when compared to existing technology, is operable on the grid or low voltage DC, and does not require a drain for condensation water as it can reuse the energy stored in the condensate as well as using the condensate water itself. Furthermore, embodiments of the present disclosure can be modular in nature and can allow for the independent heating and cooling of individual rooms or compartments within a large space.

As opposed to existing systems, more efficient and environmentally friendly air conditioning systems will be based on water or emulsion loops for the transport of exhaust heat to outside areas or exhaust cool water to a central heating area

In an exemplary embodiment of the present disclosure, the system comprises: a plurality of air-conditioning units, installed in walls or roofing of individual rooms; at least one water or emulsion loop, which extends throughout the building and provides heat transfer node/source; and external regulation units, which is responsible for the maintenance of the water/emulsion loop's static state.

Embodiments of the present disclosure include regulation units managing one or a plurality of parameters, including but not limited to: pressure, by valves and pumps; temperature, by a heater, with exemplary examples including natural gas and propane systems; a cooling mechanism, exemplary examples including a water cooling tower, or a below ground water store; filters for the removal of particulates; etc.

The principle of using distributed heat exchangers to a liquid loop is: That only one main liquid loop is required; Evaporation cooling tower technology can be employed for higher efficiency; Low pressure in the loop; and that simultaneous heating and cooling in a large application can be achieved using minimal amounts of energy.

In one embodiment, the system comprises multiple heat pump and air handler arrangements. The transport mechanism of heat or cold transport may use the same identical medium as the storage media. Due to the high efficiency of the heat/cold transport and storage system, Pelletier Solid State heat pumps may be used in a distributed fashion.

Embodiments of the present disclosure's air-conditioning system are user and independently installable. The system may require only a plumber and an electrician to install, and has additional benefits with regards to both energy and cost effectiveness. Furthermore, the use of valves situated on the connections to the fluid loop, can enable individual air conditioning units to be installed or removed, while the remaining air conditioning units with the system are in operation.

In a further embodiment of the present disclosure, the system includes a water condensation piping system, which is able to transport condensation fluid formed on the air-conditioning system outside the regulated environment. The cool or heat can be extracted using a simple heat exchanger or a supplementary heat pump to feed it back into the loop. The water condensation piping system may also comprise a carbon or reverse osmosis filter, and a connection to a water cooling tower, wherein the condensation water is able to be used as an evaporant.

In a further embodiment of the present disclosure, the system comprises multiple air-conditioning units, hereafter heat exchange units, which individual manage distinct, separate environments. The heat exchange units are able to independently heat or cool their respective environments.

In a further embodiment, the air conditioning units may employ multiple fans. The fan(s) should be powerful enough to move sufficient air over the heat pump air interface to transfer more energy than the heat pump can pump.

In a further embodiment of the present disclosure, the heat exchange unit is able to be used as both a heating and cooling device by the use of two push-pull, low on-impedance transistor stages or a double pole switchover relay, which allows the heat pump to be driven in reverse.

In a further embodiment of the present disclosure, the system's controls have multiple sensor inputs and a communication interface.

In a further embodiment of the present disclosure, the heat exchange units utilize extruded aluminum air to heat pump interfaces and machined copper as the interface from heat pump to transport medium. Aluminum may be utilized on the air side and copper on the water loop side. The system may be machined such that there is no silicone grease needed to make the coupling, but will utilize highly planed and polished surfaces that will optimally heat couple. The use of copper on the hot side of cooling mode provides the advantage that up to twice the heat can be extracted as can be input on the air side. Cooling mode will transport the heat from the cold side to the hot side but the energy used to transport the heat is approximately 1.1 times the energy that is transported: 0.9 Watts extracted+1.1 Watts to extract require 2 watts to be extracted by the water loop. Hence the air handler/heat pump unit is using copper on the water loop side with twice the thermal transport capability of the aluminum heat sink on the air side.

Embodiments of the present disclosure, can require very low or no maintenance. Furthermore, the system can be comparatively quiet, in the order of 0 dB-A, with regards to the heat-pump. Embodiments of the heat pump can have an effective life expectancy of up to 25 years while embodiments of the power electronics can have an effective life expectancy of up to 15 years. Larger embodiments of the systems may only require regular loop filter changes.

These and other aspects of the disclosed subject matter, as well as additional novel features, will be apparent from the description provided herein. The intent of this summary is not to be a comprehensive description of the claimed subject matter, but rather to provide a short overview of some of the subject matter's functionality. Other systems, methods, features and advantages here provided will become apparent to one with skill in the art upon examination of the following FIGURES and detailed description. It is intended that all such additional systems, methods, features and advantages that are included within this description, be within the scope of any claims filed later.

### BRIEF DESCRIPTION OF THE DRAWINGS

For a better understanding of the present disclosure and to show how the same may be carried into effect, reference will now be made, purely by way of example, to the accompanying drawings in which like numerals designate corresponding elements or sections throughout.

With specific reference now to the drawings in detail, it is stressed that the particulars shown are by way of example and for purposes of illustrative discussion of the preferred embodiments of the present disclosure only, and are presented in the cause of providing what is believed to be the most useful and readily understood description of the principles and conceptual aspects of the present disclosure. In this regard, no attempt is made to show structural details of the present disclosure in more detail than is necessary for a fundamental understanding of the present disclosure, the description taken with the drawings making apparent to those skilled in the art how the several forms of the invention may be embodied in practice. In the accompanying drawings:

FIG. 1 illustrates an exemplary block functionality diagram of the control electronics;

FIG. 2 illustrates a Cross Section of an exemplary embodiment;

FIG. 3 illustrates a the Heat pump from the perspective of the Water Loop;

FIG. 4 illustrates an exemplary method of construction for the present disclosure;

FIG. 5 illustrates an exemplary Air Handler Embodiment including a Suction on short side perspective, and Suction on long side perspective;

FIG. 6 illustrates an exemplary Air Handler Embodiment;

FIG. 7 illustrates an exemplary Air Handler Fixture;

FIG. 8 illustrates multiple views of an exemplary embodiment of LED Insert;

FIG. 9 illustrates an exemplary Air Handler Embodiment: Extrusion, End Cap 1, and End Cap 2;

FIG. 10 illustrates an exemplary Air Handler Embodiment, including a Top View perspective, and a Side View perspective;

FIG. 11 illustrates an exemplary Air Handler Embodiment, including a Bottom View (Airflow) perspective, and a View with Grill perspective;

FIG. 12 illustrates an exemplary system embodiment of the present disclosure; and

FIG. 13 illustrates an exemplary heat Pump Power Supply Block Diagram.

### DETAILED DESCRIPTION OF ILLUSTRATIVE EMBODIMENTS

Although the present subject matter is described with reference to specific embodiments, one skilled in the art could apply the principles discussed herein to other areas and/or embodiments without undue experimentation. All of the following descriptions and embodiments may also be adapted in various ways to suit different situations and heating and cooling needs.

The present disclosure enables a system that is meant to have optimal air to transport medium heat exchange combined with state of the art controls. Embodiments of the present disclosure may include an air-conditioning system with single or multiple small, individual heat-exchange units. Each unit is able to provide localized comfort zones, which can be turned off if there is no occupancy within the recognized comfort zone. The high efficiency of the system is achieved by a generally close and loss-less coupling of heat exchangers to air or other transport mediums.

In one embodiment of the present disclosure, the system is located inside a building, or air-conditioning space, with the exemplary system comprising a thermally insulated water loop that can conveniently reach all distributed heat-exchanger/air handler units, and a condensate pipe for transporting condensate water outside the building. Outside the building an exemplary system may additional comprise: a circulation pump, rust and particle filters, a propane or natural gas heater, one or more insulated water loop pipes, and a below ground and below freezing line optional closed loop water storage system.

The water loop can be closed, made complete, by one or more heat-pump/air handler units. The forward and return pipes are a multiple of the size of the connecting hoses or pipes going to and coming from the individual heat-pump/air-handler units acting as manifolds and exhaust manifolds.

The exemplary device can use any form of close coupled heat pumps, such as State Change Systems or Pelletier elements, to provide the heat exchange to the medium. In one embodiment, the medium used in the fluid loop may be water, which provides the highest efficiency in systems where the water temperature can be kept above freezing at all times of the year and under all circumstances. Only one media may be used, de-ionized water for example, for the storage and transport of heat. Thus, any storage tanks may be directly coupled to the heat/cold transport loop so there is no separation by pipes or walls.

In another embodiment, the medium used can be oil or an emulsion, and this has potential benefits in systems where the transport loop temperature can fall below freezing.

Embodiments of the present disclosure can be easily mass produced with a high degree of automation. Mass production could utilize a small amount of natural resources while promising a lifetime greater than that of conventional technology, namely state change refrigeration units using Freon, R22, Propane, or similar gases. The device can be used for cooling and heating by means of electronic control of the solid state heat pump.

In one embodiment, the system does not require any substance, for example silicon paste, to be placed between the heat pump element and the heat pump exchangers. The lack of this additional substance can lead to a more efficient system and a lower cost as no extraneous materials are necessary.

In one embodiment, the system's power supply and control unit are separate. This allows the power supply to be replaced as necessary, as it may have a much shorter life span than the heat exchanger module and the control electronics.

In one embodiment, the use of manifolds within the heat exchange unit can allow the parallelization of individual heat exchanger modules, which allows for optimal and even heat pump efficiency.

The thermal decoupling of all air intake surfaces and cold surfaces may eliminate any condensation outside of the drip pan.

In a further embodiment of the system, algorithms can be used to protect the solid state heat pump from operating outside a safe envelope may elongate total unit life.

The described embodiments may use distributed dampers, heat exchangers, and air handlers that are controlled from a controller integrated into a ceiling, floor, or wall unit, or part of a combined LED lighting drop-in ceiling fixture.

The present disclosure incorporates by reference co-pending PCT application PCT/US12/27352 filed Mar. 1, 2012, a copy of which is included as an appendix, which provides a method for installing and controlling a plurality of electrical devices such as lighting, air-conditioning, heating, and access control. The control may be from a plurality of sensors, so that one or more devices can be controlled according to a sensor. Sensor types include dimmers, occupancy sensors, temperature sensors, pressure sensors, daylight sensors, On/Off touch sensors, other sensor types, or a combination of sensors. This method may be applied to the present disclosure should the user decide to install a series of individual air conditioning units controlled centrally and allows for more efficient system communication. However, to the extent said included reference contradicts the present disclosure, this disclosure shall supersede.

While some embodiments may incorporate a ducting system, others may operate with a reduced ducting requirement or no ducting requirement at all, depending on many factors. Such factors may include the structure of the overall space or individual compartments being heated and cooled.

In one embodiment comprised of an air ducted chilled or heated air system, the combined LED and air outlet will have a motor driven damper that can shut, partially or fully open an air vent. The motor is driven by the LED driver power supply. The air damper will open or close depending on a thermostat measuring the room temperature by averaging inlet and outlet air temperatures.

In another embodiment using a Pelletier or magneto caloric effect heat exchanger, a construction of heat or cold transport and an opposite side air interface may be used. The Pelletier or magneto caloric effect heat exchanger comes in the form of an extrusion that in itself has a shape that incorporates appropriate surfaces and structural features to allow integration of heat transport pipes, fans, drip tray, and water connections to be easily adapted. Being an extrusion, the length will determine the BTUs that can be transferred at a certain air/extrusion temperature difference.

In one embodiment, the system may consist of a heat to air transfer plate, which may have an attractive shape and sufficient surface area to heat or cool the amount of air in the space. The embodiment may also have a Pelletier or Magneto Caloric Element, acting as a heat pump to transport the heat to or from that plate, and a block of heat conductive material such as copper, aluminum, or other suitable materials to transfer heat surface to surface from the heat pump element to a liquid medium. The embodiment may also utilize a pump to circulate the water or other liquid through the heat transfer block and the external radiator, a pipe interface from the heat transfer block to an external radiator, and a temperature control system to protect the Pelletier element and to manage optimal performance based on inside and outside temperatures as well as freezing control. The embodiment may also include an outside radiator or evaporation Cooler and the system may be filled at highest point.

In one embodiment, the heat exchange unit and system combines a dehumidifier, drip tray, and condensed water removal via miniature pump. An accessible filter, drip pan, and air interface allow easy replacement of the air filter and cleaning of air interface.

When this exemplary system is cooling, condensation may form on the heat to air transfer plate. Gravity will make this condensation run down the plate into a collection area. The condensation may drip in that collection area onto the hot block, which transfers the heat from the heat pump element to the liquid media. In this exemplary embodiment, the system will deliberately, by its controls, run at an exhaust temperature of about 100 deg C so that any water dripping onto it will evaporate rather quickly having a net zero result to the room's humidity.

In one embodiment, the humidity can be controlled by lowering the exhaust temperature as part of the system control electronics, thus slowing the evaporation process and increasing the amount of condensation water in the collection area. A pump will sense this and pump the excess water outside the building or into a specific condense water exhaust pipe, which can transport this water to a water evaporation cooling tower or other disposal.

In one embodiment, the power source for the control unit and heat pump is a 48 volt bus power, which may be 300, 400, or 1000 watts for a single unit. The controller manages the pump, return and forward water temperatures, and plate temperature dew point.

In another embodiment, the Unit can be run off of a regulated 48V DC supply or from a 48V (nominal) battery bank. This allows the units to be used in applications where the energy is coming from the line, an alternative solar and/or wind source, or where Batteries are being used for load shifting.

In another embodiment, an air handler or air-damper is integrated with a LED lighting fixture in form of a 2′×2′, 2′×4′, 60 cm×60 cm or 60 cm×120 cm drop in ceiling panel.

Another embodiment for an air handler is specific to a small air outlet of an approximately 5.5″×11.5″ effective area to pull and distribute air. To solve problems resulting from space and room topology restrictions and keep flexibility in applications, two air flow adapters can be used to either pull air from the short side and push air on the long side or vice versa.

It is often difficult to extrude small cavities in aluminum or copper, which would be required to increase the surface area of the water, emulsion, or other substance. It has been demonstrated that it is often easier and more cost efficient to extrude copper but other suitable materials may be used for use on both the air-interface and water surfaces. Greater extrusion would allow maximum contact to minimize the number of cavities and keep the liquid flow to a minimum, as moving the media costs pump energy. This further reduces the running costs of an air conditioning system.

In this scheme, the cavity is bigger than ideal. By inserting a plastic or other extruded filler, the water has to squeeze into the small cavity around it, making contact with the walls of the device for optimal heat transfer from the solid to the medium.

The drip tray, air channels and fins can all be in one extruded unit allowing modularity by cutting, for example, 2′, 4′ or 8′ length a 1000, 2000 or 4000 BTU capable air transfer unit can be produced.

### Heat Pump

In one embodiment the input power can range from 150 Watt to 600 Watt for solid-state heat pumps or air damping systems.

In another embodiment, the power supply is a 400-Watt switch mode and power factor corrected power source, which generates a bus voltage of 53 Volts. This is sufficient to charge a bank of 48-volt batteries. Two push-pull, low on-impedance transistor stages or a double pole switchover relay allow the heat pump to be driven in reverse. This allows for use as a heating or cooling device.

In one embodiment, the electronic circuit consists of a Power Factor Corrected (PFC) Switch Mode Power Supply (SM) feeding an internal/external 53 Volt bus (46 to 60 Volts). The current capability of the 53 Volt Supply should be in about the 15 A range, allowing usable 795 Watts.

The power supply, when driven from the electrical grid, should run with an efficiency of at least 90%, resulting in about 80 watts of heat generated by the power supply, which will have to be taken away by the water loop.

In one embodiment, the system is supplied by one or more current sources, which may deliver a constant current within a programmable range of about 1 A to 10 A. The precise value depends on the heat pump elements used. Only same type elements can be used within one channel so that even heat/cold distribution is achieved.

In one embodiment, the power electronics interface to the water loop, and the heat transfer is located at the water exit of the heat pump.

In one embodiment, the system comprises three (3) heat sensor inputs for heat/cold sensors that comprise precision NTC surface mount resistors, which may have to be calibrated. The sensors may be located at: 1) a surface connected to the water loop, 2) the air-interface surface, and 3) in the airstream of the air intake.

Two independent relay outputs (250 Volts 10 A AC) allow the control of: 1) an external fan driven from AC line voltage and 2) current source driven from AC line voltage.

Fan power supply and control can allow the driving of one or more 12 Volt DC fans with up to 3-Watts power consumption. The micro controller firmware can adjust the output in about 10% increments.

Three temperature sensor inputs that are analog averaged sensing inputs with a sensing capability from 0° C. (32° F.) to 100° C. (212° F.) on each channel.

Water Pump Power Supply and Controls drive a push pull tandem displacement pump.

Failure monitoring supersedes all operations:

Water Loop Sensor: above 60° C. (140° F.)
below 4° C. (40° F.)
   Air Interface Sensor: below 7° C. (47° F.)
above 80° C. (176° F.)

There are fan control outputs to allow driving up to two 12 volt fans using a constant current source that is controllable by the algorithm for speed control of the fan.

The temperature on the heat-pump to air interface side may be measured by one or more temperature sensor(s). The temperature of the heat sink and water jacket may be measured by another temperature sensor. The air temperature may be measured on the air intake of the unit.

A louver control output can allow better thermal insulation from a unit that is turned off. This feature can prevent the air from becoming heated, as a turned-off heat pump will gradually take on the transport media's temperature on the air interface side. A louver status switch may allow the louver status to be determined by the algorithm. However, the savings are minute relative to the expense for the benefit.

The algorithm for one embodiment has a main loop that looks at the temperature requested, which has been pre-set by remote control or wired temperature and air control.

In one embodiment, Main Loop On Conditions may be characterized as follows: The Pre-Set ON/OFF Parameter has to be set to ON for the main loop to be able to be calling the 1^{st} sub loop. If the air-intake temperature is 1 deg C (2 deg. F) or more above or below the temperature target the 1^{st} sub loop will be called.

In one embodiment, Main Loop Off Conditions may be characterized as follows: If the Pre-Set ON/OFF Parameter is set to OFF the main loop will stop calling the 1^{st} sub loop. If the unit has been cooling and temperature target has reached 0.5 deg C (1 deg. F) below the pre-set temperature, the main loop will stop calling the 1^{st} sub loop and turn heat pump off. If the unit has been heating and temperature target has reached 0.5 deg C (1 deg. F) above the pre-set temperature, the main loop will stop calling the 1^{st} sub loop and turn heat pump off.

The 1^{st} sub loop protects the heat pump by using the temperature reading of the water jacket, which relates directly to one surface of the heat pump and compares it with the temperature reading of the air interface surface, the other surface of the heat pump.

In one embodiment, the 1st sub loop may be characterized by the following: 1) When 1^{st} Sub Loop OFF, if any surface reaches or is above +80 deg C (176 deg F) the 1^{st} sub loop will turn heat pump off. This prevents water from gassing and the solder of the heat pump to melt (at 135 deg. C). If any surface reaches or is below +4 deg C (7.2 deg F) the 1^{st} sub loop will turn heat pump off. This prevents freezing of the water loop or ice building on the air surface. 2) When 1^{st} Sup Loop ON: If the temperature target is below the current air intake temperature then turn on cooling and allow calling 2^{nd} sub loop. If the temperature target is above the current air intake temperature then turn on heating and allow calling 2^{nd} sub loop.

In another embodiment, the 1st sub loop may be characterized by the following: 1) When 1^{st} Sub Loop OFF, if any surface reaches or is above +100 deg C (176 deg F) the 1^{st} sub loop will turn heat pump off. This prevents water from gassing and the solder of the heat pump to melt (at 135 deg. C). If any surface reaches or is below +4 deg C (7.2 deg F) the 1^{st} sub loop will turn heat pump off. This prevents freezing of the water loop or ice building on the air surface. 2) When 1^{st} Sup Loop ON: If the temperature target is below the current air intake temperature then turn on cooling and allow calling 2^{nd} sub loop. If the temperature target is above the current air intake temperature then turn on heating and allow calling 2^{nd} sub loop.

In one embodiment, the 2^{nd} sub loop deals with fan control, which can be low, medium, high or automatic. The fan mode is controlled by the Pre-Set Parameter for Fan Mode, which can be set by the remote control. The default is set to “Automatic”. In automatic mode the speed controls the optimum air interface for maximum heating or cooling effect and the heat pump is permanently ON In low, medium or high mode the fan is at a constant speed and the heat pump controls are responsible to optimize the air interface.

In one embodiment, the water pump may be a tandem displacement pump. The pump works on the principle of a moving membrane excited by an electro magnet, changing its polarity once or twice a second. The pump output is therefore a single or dual push pull output similar to that of an audio amplifier.

The water pump control can also be used as the louver control output in case of an air damper application, not using a local heat pump.

The power electronics of the exemplary device can be thermally coupled to the OUT Manifold thus achieving a water cooled heat sink which eliminates the use of additional cooling fans for the power electronics. This thermal coupling can reduce the noise the unit produces inside the building.

The exemplary device is suitable for damp locations and has an enclosure rating of IP54. Suitability has to be evaluated with the environment the device is installed in.

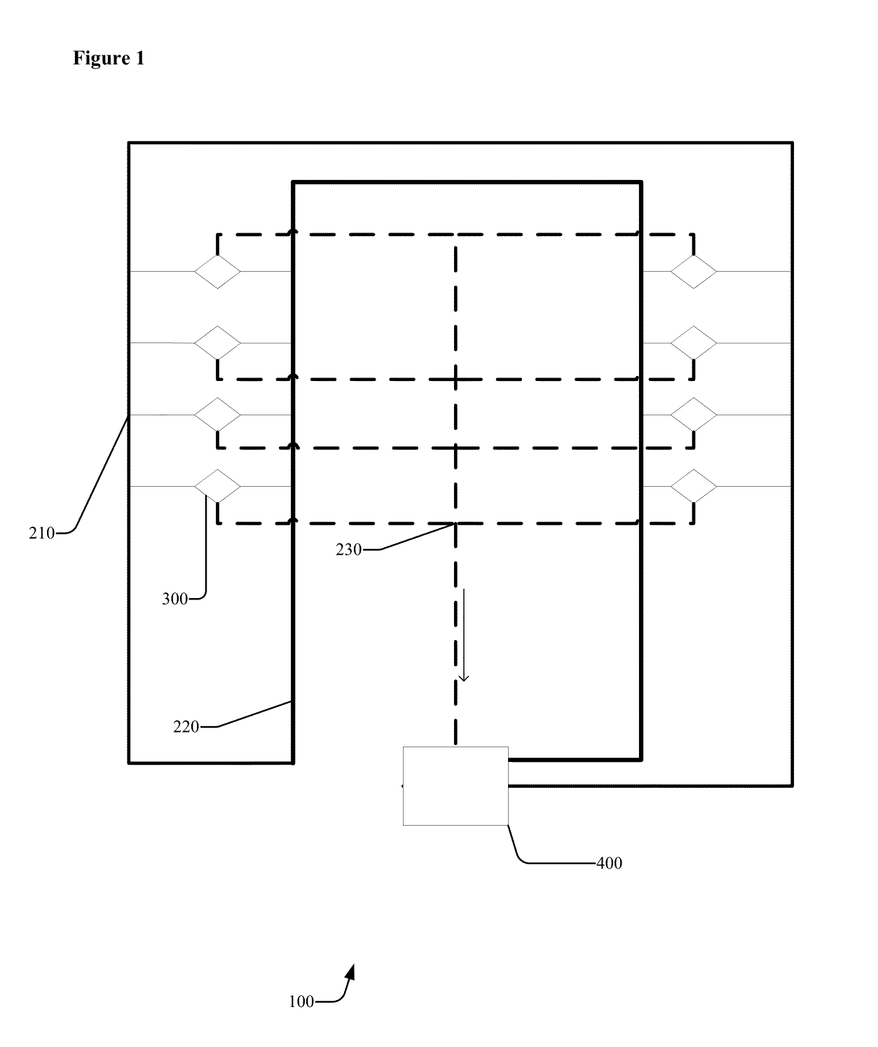

FIG. 1 schematically presents an exemplary embodiment of the present disclosure, wherein the system 100 comprises a fluid loop with both an in line 210 and a out line 220 connected to a plurality of heat exchange units 300. The heat exchange units are able to independently cool or heat a room by either. The system further comprises a regulation unit 400, as well as a water condensation line 230.

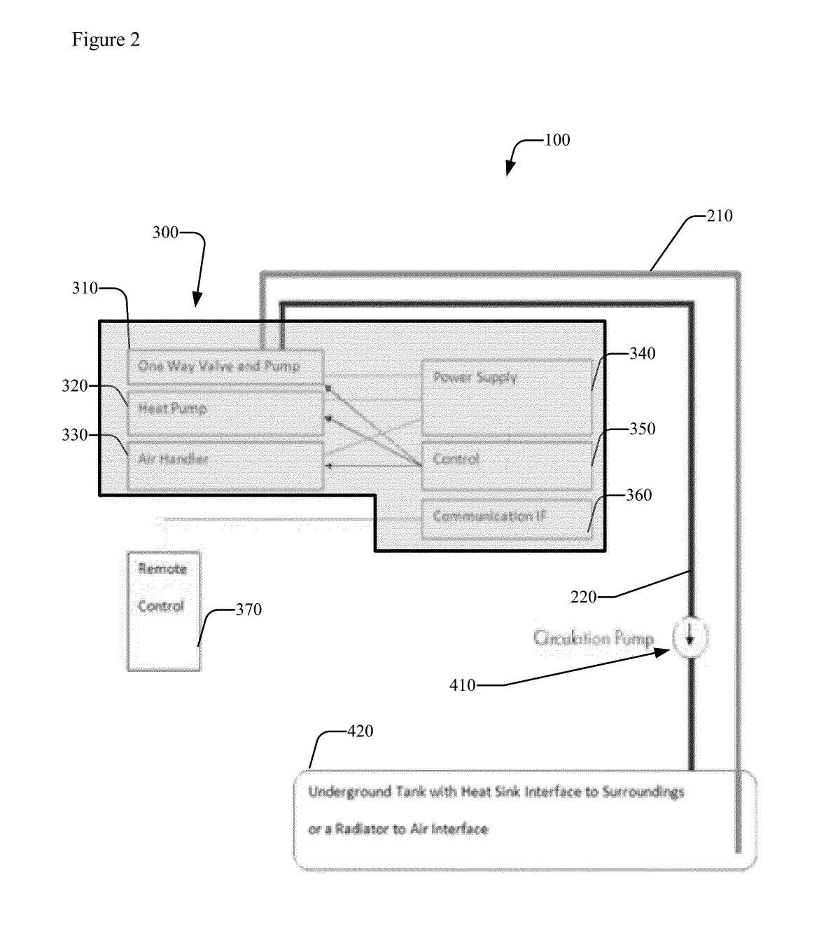

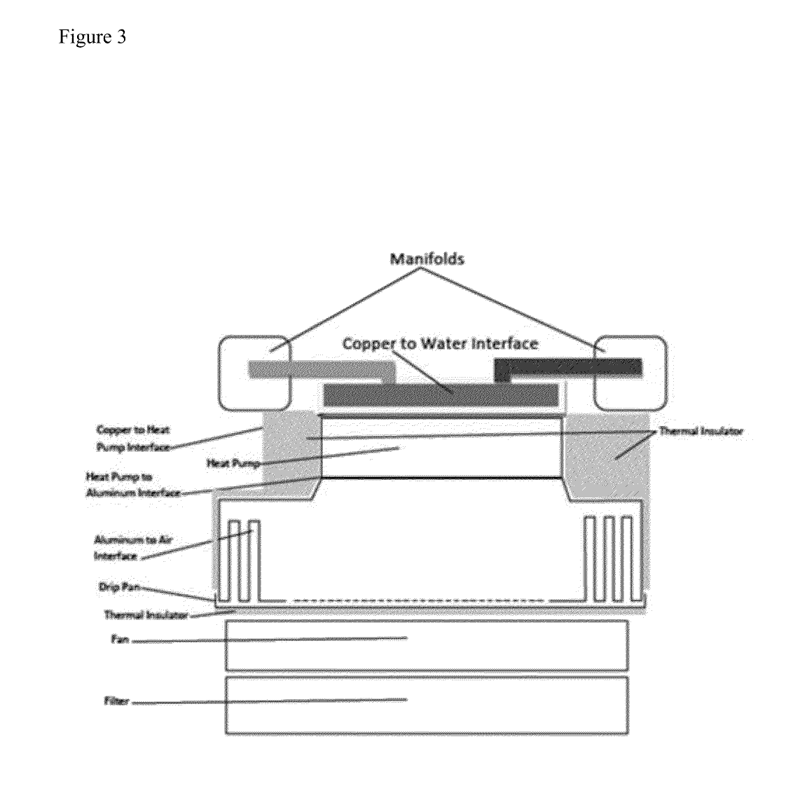

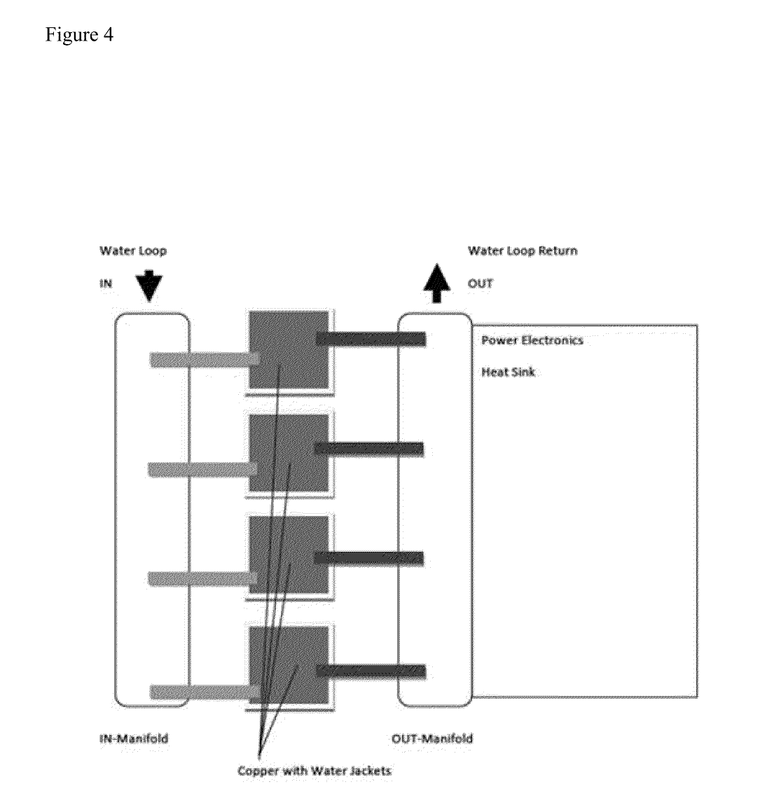

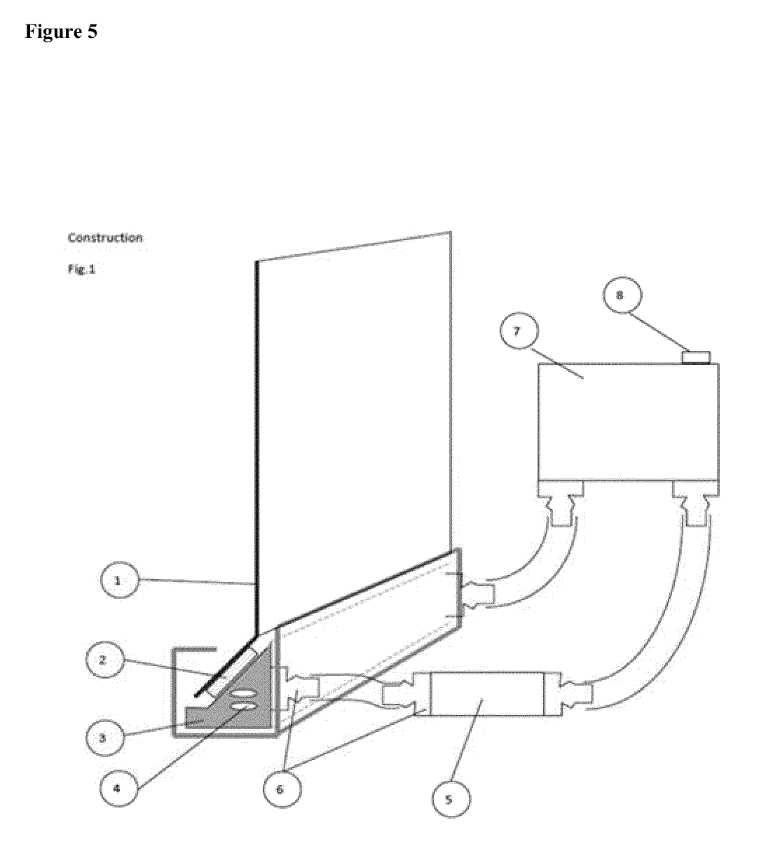

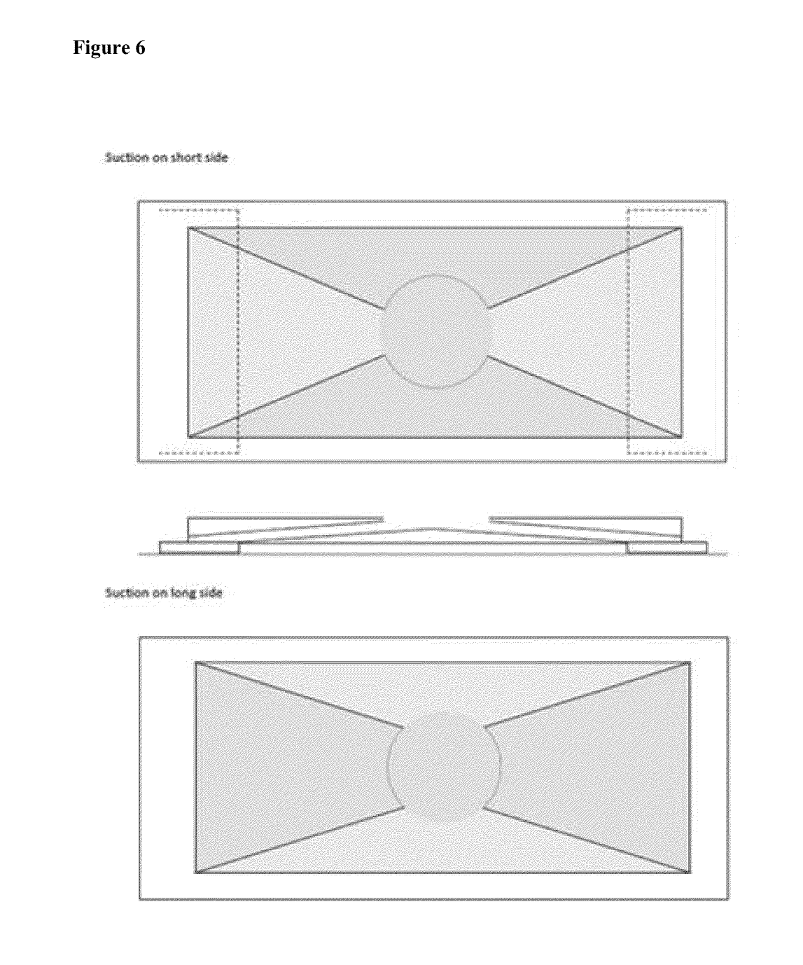

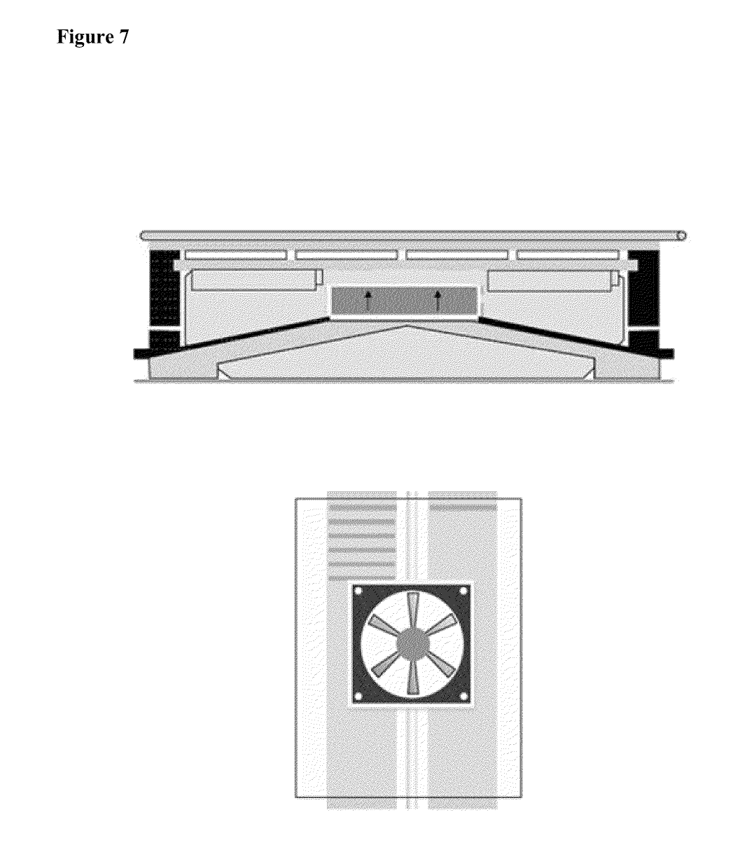

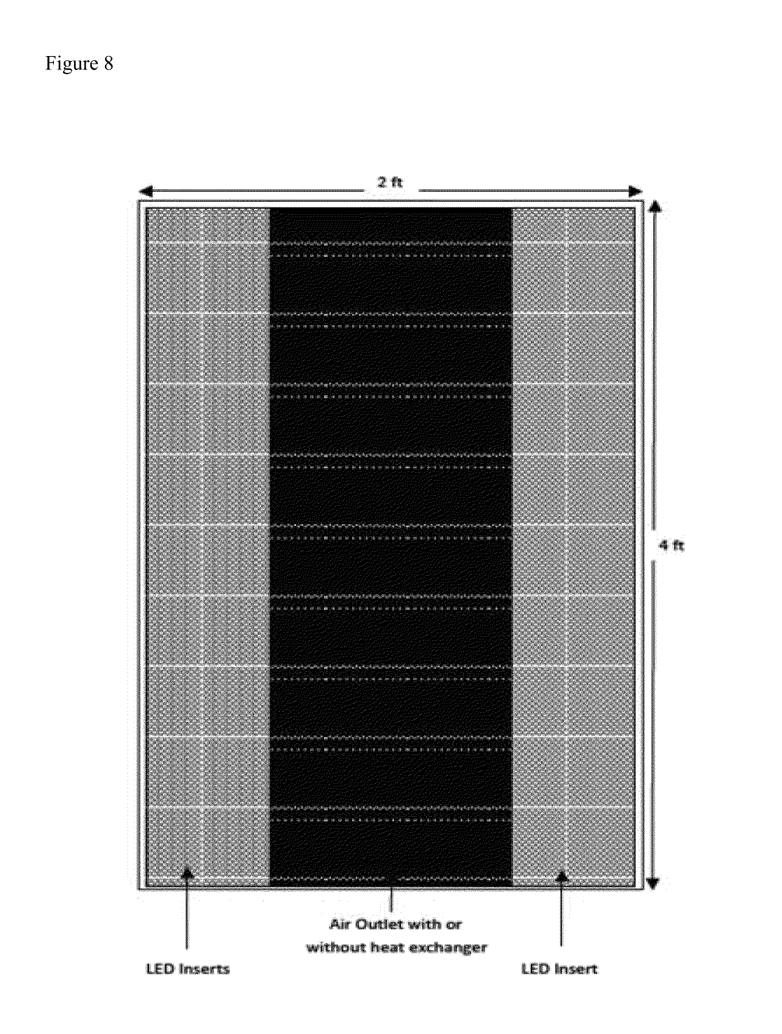

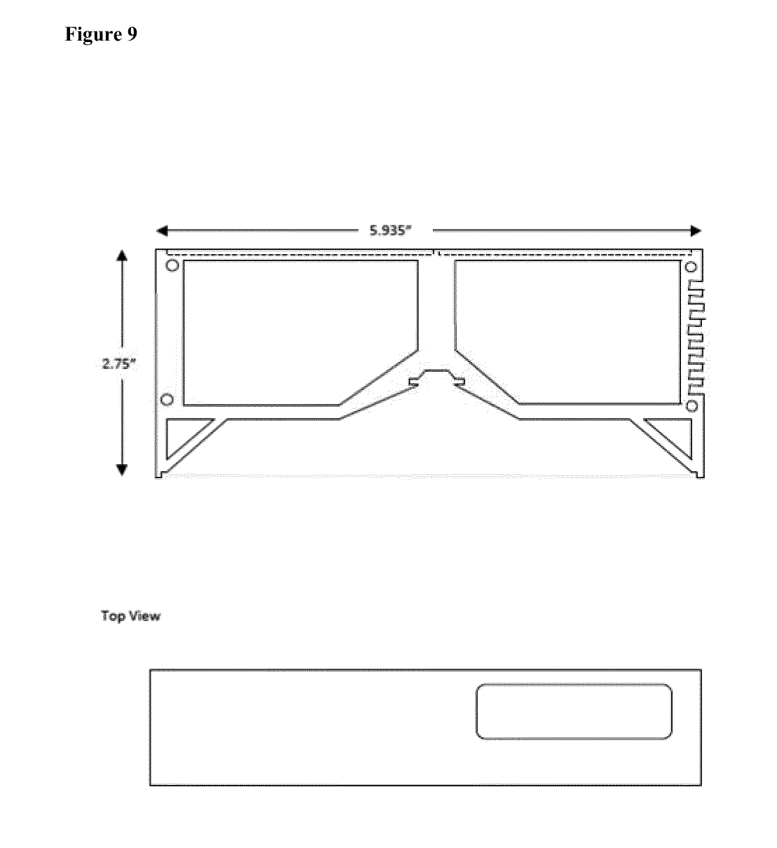

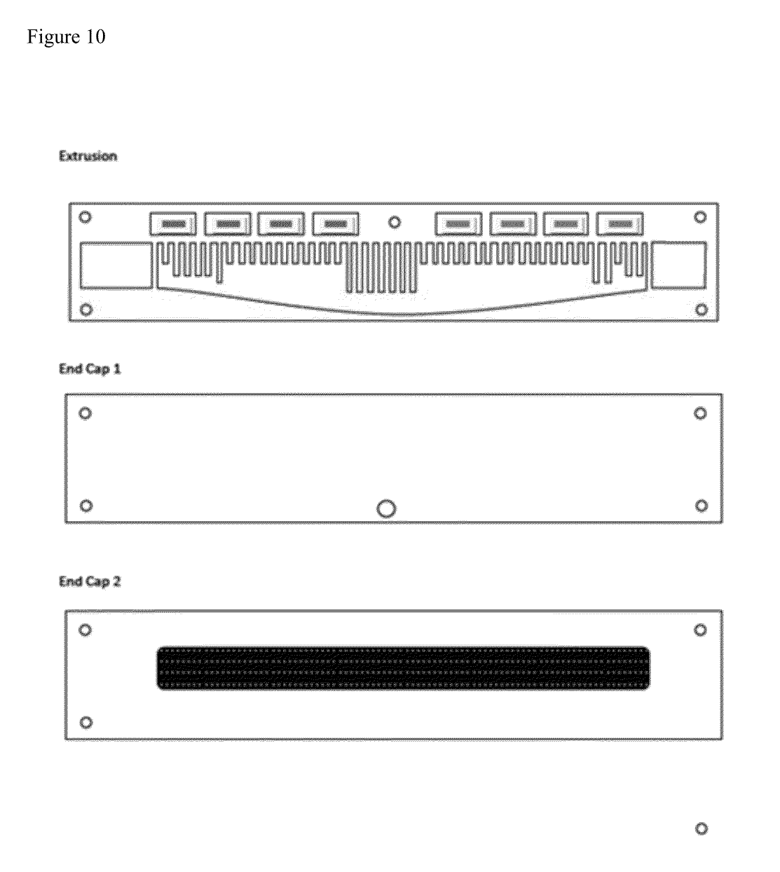

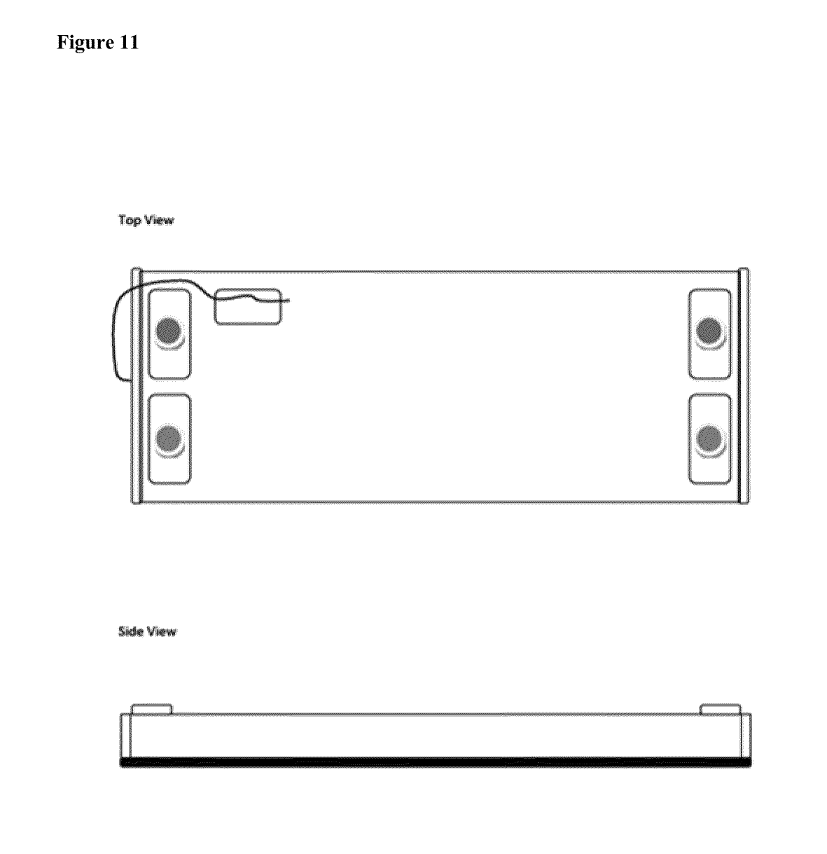

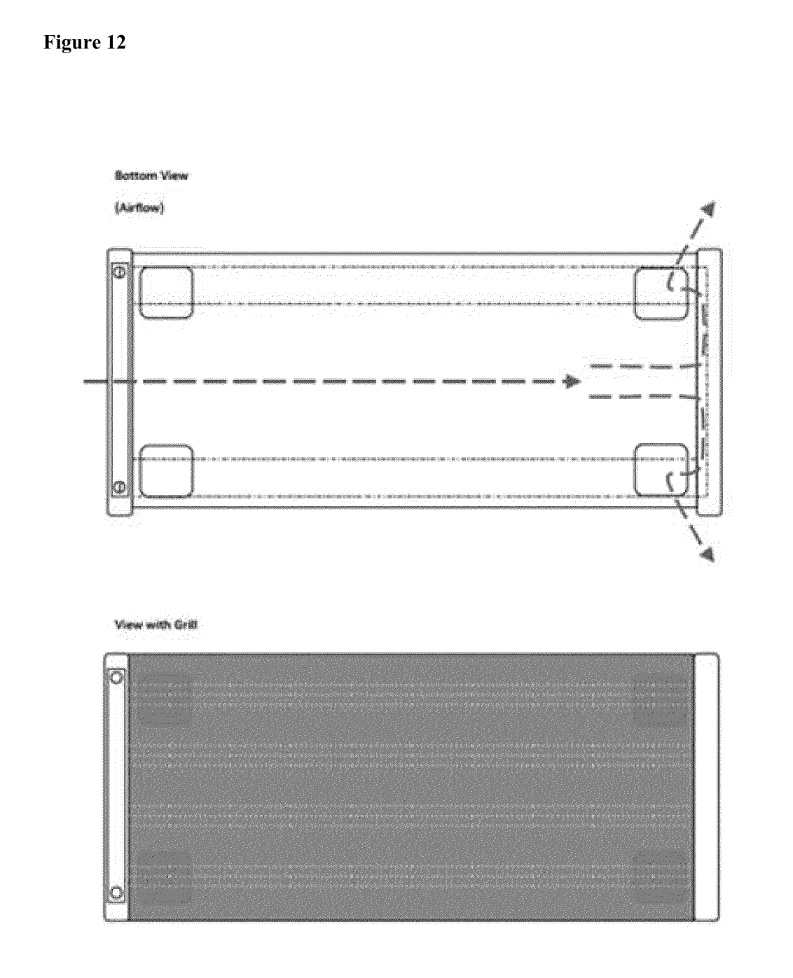

FIG. 2 schematically illustrates an exemplary single heat exchange unit system as well as an exemplary heat exchange unit. The exemplary heat exchange unit 300 comprises: a one-way valve and pump 310, which determines the direction of fluid flow through the system; a heat pump 320, wherein exemplary examples can include a Pelletier Solid State Heat Pump, or a magneto caloric effect heat exchanger; an air handler 330, which actuates the intake and discharge of air from the heat exchange; the power display 340; the control unit 350; and a communication unit, which in the exemplary embodiment is an infrared system. The exemplary heat exchange unit portrayed in FIG. 2 is connected to an external remote control 370. FIG. 2 further presents the exemplary system comprising in 210 and out 220 fluid lines, a circulation pump 410, and an exemplary temperature regulation unit 420, which is presented in the current embodiment as an underground tank with a heat sink interface to the surroundings, or a radiator with an air interface. Other embodiments of the present disclosure can include a variety of coolant mechanisms.

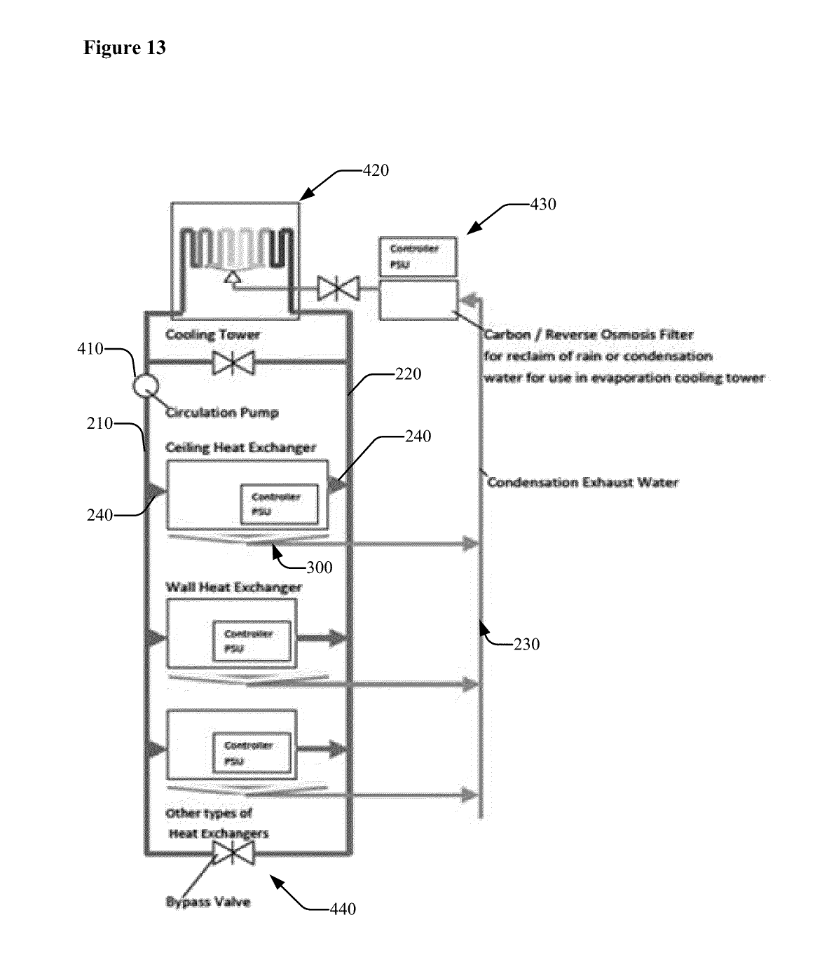

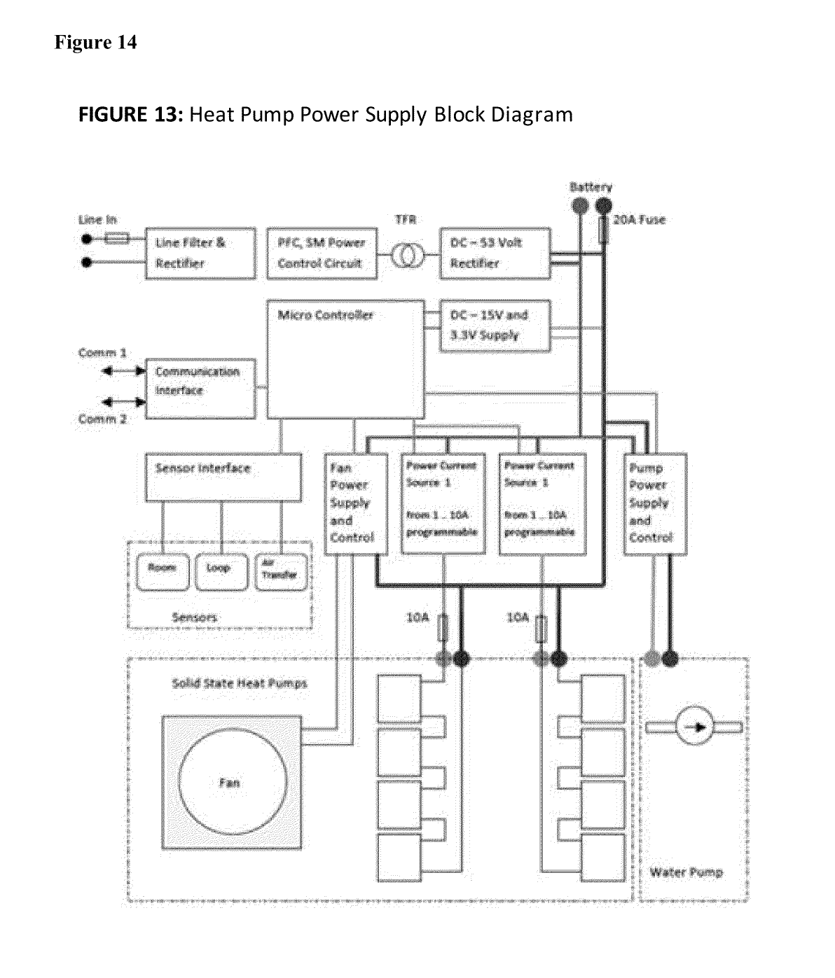

FIG. 13 schematically illustrates an exemplary embodiment of the present disclosure, wherein the system comprises a plurality of heat exchange units 300, including both ceiling mounted and wall mounted heat exchange units, a fluid loop including a cold 210 and a hot lines 220, where the heat exchange units are provided with at least two connections 240 to the fluid loop. The exemplary fluid loop further comprises or is connected to, a bypass valve 440, a circulation pump 410, and a temperature regulation unit 420, which is presented in the current Figure as a cooling tower. The system further comprises a water condensation line 230, and a carbon/reverse osmosis filter 430, which enables rain water or the condensation water from the heat exchange units to be utilized in the cooling tower.

The scope of the present disclosure is not limited to the specific examples and embodiments described above. The system and method are applicable to various air-conditioning systems. Those with ordinary skill in the art will recognize that the disclosed embodiments have relevance to a wide variety of areas in addition to those specific examples described above.

The foregoing description of the exemplary embodiments is provided to enable any person skilled in the art to make or use the claimed subject matter. Various modifications to these embodiments will be readily apparent to those skilled in the art, and the generic principles defined herein may be applied to other embodiments without the use of the innovative faculty. Thus, the claimed subject matter is not intended to be limited to the embodiments shown herein but is to be accorded the widest scope consistent with the principles and novel features disclosed herein.

It is intended that all such additional systems, methods, features, and advantages that are included within this description be within the scope of the claims.

What is claimed is:

1. An air-conditioning system comprising:
at least one power source;
at least one transfer fluid;
at least one heat exchange unit, wherein said at least one heat exchange unit actuates a change in an air temperature in an enclosed environment;
at least one fluid loop, wherein said fluid loop contains one of said at least at least one transfer fluid;
at least one sensor;
at least two connection between said heat exchange unit and said at least one fluid loop, wherein said connections allow the flow of said transfer fluid to and from said at least one fluid loop to said heat exchange;
whereby flow of said transfer fluid through said heat exchange actuates at least one of:
transfer of heat from said at least one transfer fluid to said at least one heat exchange unit and thereby to said environment; and/or transfer of heat from said environment to said at least one heat exchange unit and thereby to said at least one transfer fluid;
at least one regulation unit connected to said fluid loop, said regulation unit regulating a least one parameter within a defined range.

2. The at least one regulation unit of claim 1, wherein said at least one regulation unit comprises at least one of:
a pump; wherein said pump regulates pressure of said fluid within said at least one fluid loop;
a heater; wherein said heater actuates the raising of the temperature of said at least one transfer fluid,
an underground tank with heat sink; wherein temperature moves from said fluid to environment;
a water cooling tower, wherein said water cooling tower actuates the lowering of the temperature of said at least one transfer fluid,
at least one filter; wherein said filter actuates the collection of particulates in said at least one fluid.

3. The system of claim 1, wherein a plurality of heat exchange units independently actuate the change in temperature of a plurality of enclosed environments, wherein said independent temperature change can includes both independent heating and cooling and independent difference in temperature, with respect to individual enclosed environments.

4. The transfer fluid in claim 1, wherein said transfer fluid is one of: water; de-ionized water; oil; or emulsified fluid.

5. The system of claim 1, wherein said transfer of heat by said heat exchange does not actuate a state change.

6. The air-conditioning system of claim 1, wherein said system additionally comprises a condensate pipe, whereby said condensate pipe actuates the transfer of condensation fluid formed on said heat exchange unit to said external regulation unit, whereby said external regulation actuates release of said condensation fluid into atmosphere.

7. The air conditioning system of claim 2 and claim 5, wherein said system additionally comprises a reverse osmosis filter connected to said condensation pipe; whereby reverse osmosis filter treats said condensate water, whereby cooling tower utilizes treated water to actuate a decrease in temperature of said at least one fluid.

8. The heat exchange unit of claim 1, comprising:
At least one air intake;
At least one air outflow;
at least one Fan;
a plurality of valves;
at least one solid state Heat Pump, in thermal contact with said fluid loop or said fluid loop connections.

9. The solid state heat pump of claim 8, wherein said solid state heat pump is one of: Pelletier Solid State Heat Pump, or magneto caloric effect heat exchanger.

10. The at least one sensor of claim 1, wherein said at least one sensor is one of:
a sensor connected to fluid loop, wherein said fluid loop sensors measure temperature of fluid within fluid loop;
a sensor located within said at least one enclosed environment, wherein said sensors measure at least one of: temperature, and humidity;
a sensor within heat exchange unit, wherein said sensors measure at least one of: temperature of air flow into said heat exchange unit, or temperature of air flow out of said heat exchange unit.

11. The at least one power source of claim 1; wherein said power source is one of: fixed line electricity; solar generated power; or at least one battery supplied power.

12. The system of claim 1, wherein said connections between said fluid loop and said at least one heat exchange unit additional comprises valves, whereby closing of said valves enables the independent decoupling of the heat exchange unit from said system.

13. A method for the air-conditioning of at least one room, comprising:
circulation of at least one transfer fluid;
the intake of air flow to at least one independent heat exchange unit;
a change in ambient temperature actuated by a heat exchange unit comprising one of: the transfer of heat from transfer fluid to an air flow, or the transfer of heat from an air flow to said transfer fluid;
the outflow of air flow of differing temperatures from said intake air flow; and
the regulation of a plurality of parameters of said at least one transfer fluid, said plurality of parameters comprising: pressure; quantity of particulates; temperature.

14. The method of claim 12, further comprising:
the transfer of condensation water from said at least one heat exchange unit to at least one cooling tower via a reverse osmosis filter after the extraction of usable heat or cold for re-injection into the loop by means of heat exchanger or heat pump.

15. The method of claim 12, further comprising:
the supply of power by at least one of: a solar power source, a fixed line power source, or a battery power source.
